(19) United States
(12) Patent Application Publication
(10) Pub. No.: US 2003/0150299 A1
(43) Pub. Date: Aug. 14, 2003

(54) Switching assembly of ratchet wrench

(76) Inventor: Yu-Tang Chen, Taichung (TW)

Correspondence Address: BROWDY AND NEIMARK, P.L.L.C., 624 Ninth Street, N.W., Washington, DC, 20001-5303, US

(21) Appl. No.: 10/114,980

(22) Filed: Apr. 4, 2002

(30) Foreign Application Priority Data
Feb. 8, 2002 (TW) 91201652

(51) Int. Cl. B25B 13/46

(52) U.S. Cl. 81/63.2

(57) ABSTRACT

A ratchet wrench comprises a handle, which has a head at an end thereof. The head has a receive hole, a first chamber and a second chamber. A driving member is received in the receive hole of the head for free rotating. The driving member has a teeth portion at out surface thereof. A pawl has a teeth portion at a side thereof and a driven portion at the other side thereof. The pawl is received in the first chamber of the head with the teeth portion thereof meshing with the teeth portion of the driving member, and a switch device has a body and a turning piece. The body of the switch device is received in the second chamber of the head to be turned between a first position and a second position. The body disposes an elastic driving device thereon to be against the driven portion of the pawl and two shoulder portions at two sides of the elastic driving device respectively. Whereby when turns the switch device will drive the pawl to move to a side and the shoulder portion will be against the pawl.

### FIELD OF THE INVENTION

The present invention relates to a ratchet wrench, and more particularly to an improved switching assembly of ratchet wrench.

### BACKGROUND OF THE INVENTION

In the prior art, U.S. Pat. No. 6,282,992 showed a ratchet wrench, which can switch the ratchet wrench to turn loose or to turn tight a nut or a bolt. Please refer to FIG. 10, the ratchet wrench 5 provided a switch device 81, which disposes an elastic driving member 811 at front side thereof to push a pawl 82. The pawl 82 will mesh with a driving member 83, which is to driving a bolt (or a nut) to turn. If user turn the switch device 81 to make the pawl 82 meshing with the driving member 83 at the right side thereof, as shown in FIG. 10, user can turn the ratchet wrench 4 counterclockwise to drive a bolt (not shown) to turn. But if user turn the ratchet wrench 4 clockwise, the pawl 82 will depart from the driving member 83 automatically to make the ratchet wrench 4 can turn reversibly but keep the bolt still.

For facilitating to turn the ratchet wrench reversibly, there must be a space S left between the pawl 82 and the switch device 81 for the pawl 82 can depart from the driving member 83. But the space S will also make the pawl 82 having a part of teeth at the tail end thereof not meshing with the driving member 83 when turn the ratchet wrench counterclockwise as the dot line shown in FIG. 10. That will make the ratchet wrench 4 having a weak power to turn the bolt.

Similar invention also showed in U.S. Pat. No. 6,282,992.

FIG. 11 shows an earlier invention of the inventor, which provides a ratchet wrench 5 to overcome the drawback of the ratchet wrench 4 as described above. The ratchet wrench 5 provide a switch device 91 with shoulder portions at two sides thereof to be against a pawl 92 when turning the switch device 91 to right or to left. Thus, the pawl 92 will have the whole teeth thereof meshing with the driving member 92 to enhance the power to turn the bolt. The only problem of the ratchet wrench 5 is that the pawl 92 will not easy to depart from the driving member 93 when turning the ratchet wrench reversibly.

### SUMMARY OF THE INVENTION

The primary objective of the present invention is to provide a ratchet wrench, which has a larger power to drive a bolt or a nut to turn and will not interfere with the pawl departing from the driving member when turning reversibly.

According to the objective of the present invention, a ratchet wrench comprises a handle, which has a head at an end thereof. The head has a receive hole, a first chamber and a second chamber, wherein the first chamber communicating with the receive hole at a side thereof and communicating with the second chamber at the other side thereof. A driving member is received in the receive hole of the head for free rotating. The driving member has a teeth portion at out surface thereof. A pawl has a teeth portion at a side thereof and a driven portion at the other side thereof The pawl is received in the first chamber of the head with the teeth portion thereof meshing with the teeth portion of the driving member, and a switch device has a body and a turning piece. The body of the switch device is received in the second chamber of the head to be turned between a first position and a second position. The body disposes an elastic driving device thereon to be against the driven portion of the pawl and two shoulder portions at two sides of the elastic driving device respectively. Whereby when turns the switch device will drive the pawl to move to a side and the shoulder portion will be against the pawl to support the pawl having the whole teeth portion meshing with the teeth portion of the driving member but not interfering with the handle being turned reversibly.

### BRIEF DESCRIPTION OF THE DRAWINGS

FIG. 1 is an exploded view of a first prefer embodiment of the present invention;

FIG. 2 is a sectional view of the first prefer embodiment of the present invention in combination;

FIG. 3 is a top view in part of the first prefer embodiment of the present invention;

FIG. 4 is a top view of the first prefer embodiment of the present invention, showing the switch device being turned to the first position;

FIG. 5 is a top view of the first prefer embodiment of the present invention, showing the switch device being turned to the second position;

FIG. 6 is a perspective view of the first prefer embodiment of the present invention, showing relative action between the switch device, the pawl and the driving member in turning the ratchet wrench;

FIG. 7 is a perspective view of the first prefer embodiment of the present invention, showing relative action between the switch device, the pawl and the driving member in turning the ratchet wrench reversibly;

FIG. 8 is a perspective view of a second prefer embodiment of the present invention, and

FIG. 9 is an exploded view of a third prefer embodiment of the present invention.

FIG. 10 is a sectional view of a ratchet wrench according to prior arts.

FIG. 11 is a sectional view of another ratchet wrench according to prior arts.

### DETAIL DESCRIPTION OF THE INVENTION

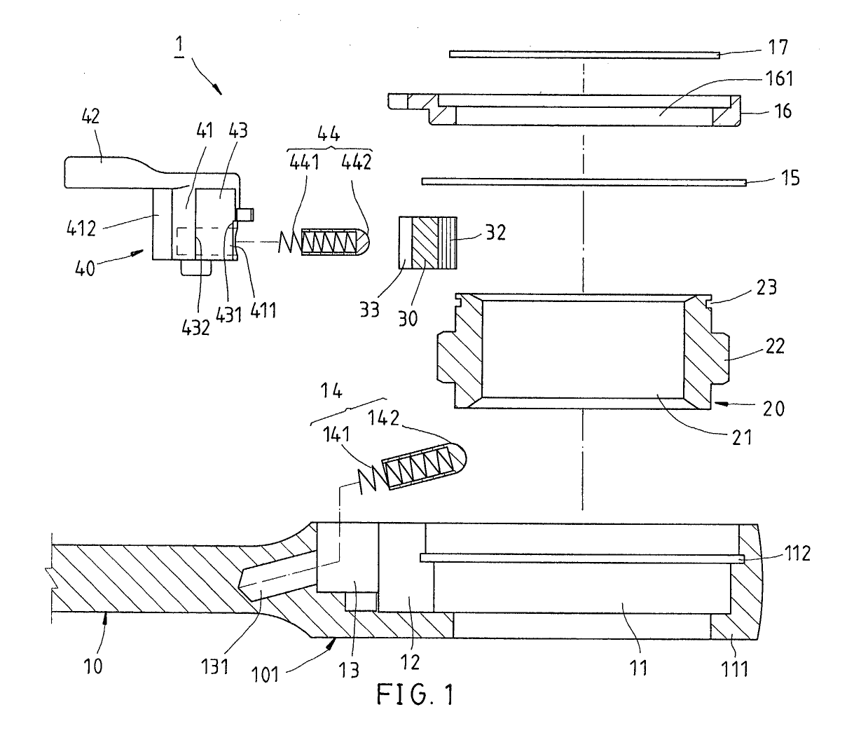

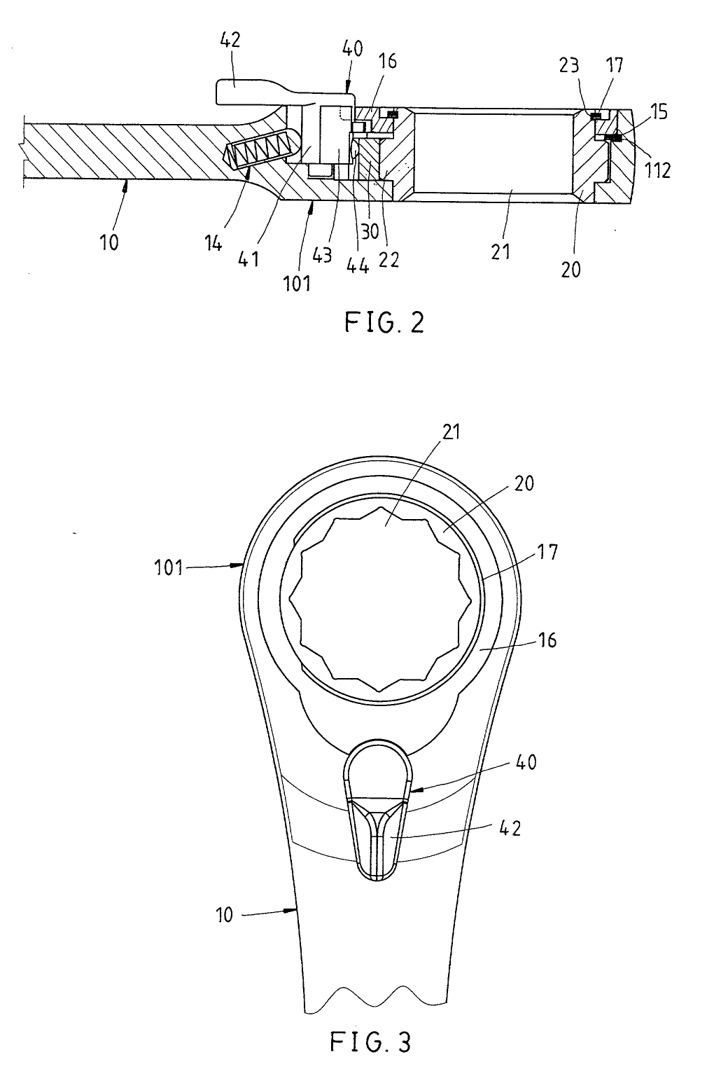

Please refer to FIGS. from FIG. 1 to FIG. 3, a ratchet wrench 1 of the first prefer embodiment of the present invention comprises:

A handle 10 has a head 101 at an end thereof. The head 101 disposes a receive hole 11, a first chamber 12 and a second chamber 13 in sequence, wherein the first chamber 12 has a side thereof communicating with the receive hole 11 and the other side thereof communicating with the second chamber 13. Both of the first chamber 12 and the second chamber 13 are opening at a side of the head 101. The receive hole 11 has a flange 111 at an end thereof to make the receive hole 11 having a smaller diameter opening at this end. The receive hole 11 further has a first lock slot 112 at interior sidewall thereof. The second chamber 13 has a recess 131 at interior sidewall thereof, which mounts an elastic position device 14 therein. The elastic position device 14 consists of a spring 141 and a rod 142 in the present embodiment.

A driving member 20 has a polygonal hole 21 for engaging to a bolt or a nut (not shown). The driving member 20 has a teeth portion 22 at out surface thereof and a second lock slot 23 at a side of the teeth portion 22. The driving member 20 is received in the receive hole 11 of the handle 10 for the flange 111 being against the bottom side the teeth portion 22. A C-ring 15 is mounted in the first lock sot 112 and is against the top end of the teeth portion 22 of the driving member 20 for securing the driving member 20 in the receive hole 11 but allowing the driving member 20 to rotate.

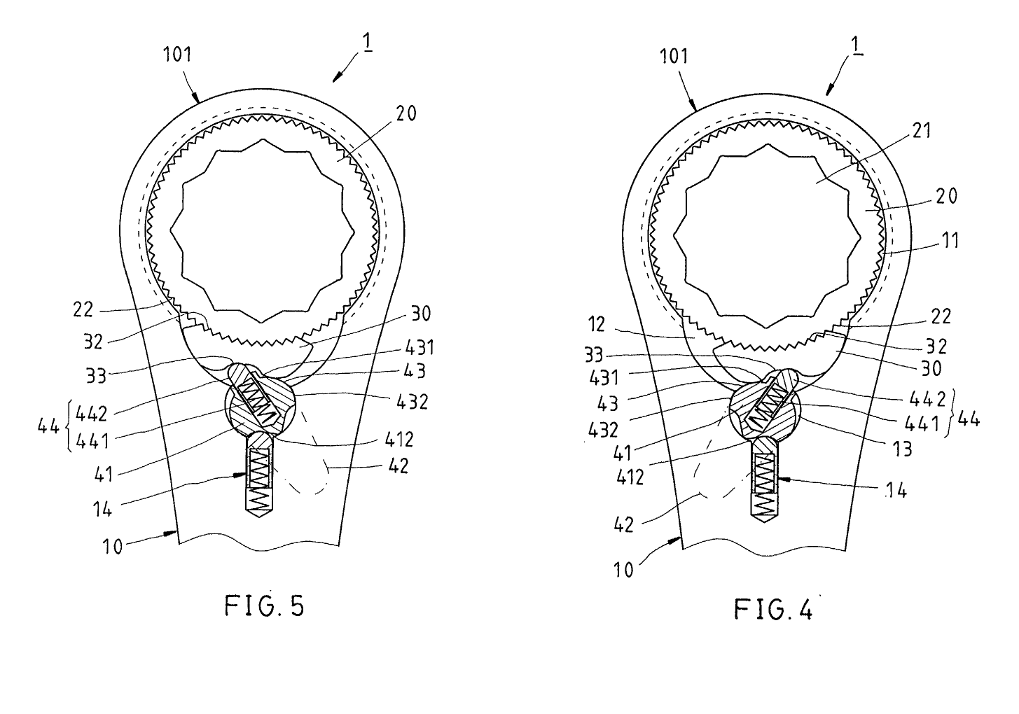

A pawl 30, which is a curved block, has a teeth portion 32 at the side of curved inwards and a driven portion 33 at the other side. The driven portion 33 is a groove in the present embodiment. The pawl 30 is received in the first chamber 12 of the handle 10 for the teeth portion 32 thereof facing to the driving member and being to mesh with the teeth portion 22 of the driving member 20. The pawl 30 can be driven to move between a first position (as shown in FIG. 4) and a second position (as shown in FIG. 5).

A switch device 40 has a body 41 and a turning piece 42. The body 41 has a recess 411 and two position portions 412 at the other side. The position portions 412 are two grooves in the present embodiment. The body 41 further has two shoulder portions 43 respectively locating at two sides of the recess 411. Each shoulder portion 43 has a proximal end 431, which is closing to the recess 411, and a distal end 432, which is away from the recess 411. The shoulder portion 43 is a curved outwards surface extending from the proximal end 431 to the distal end 432. An elastic driving device 44, which consists of a spring 441 and a rod 442, is mounted in the recess 411 of the body 41 of the switch member 40.

The body 41 of the switch device 40 is received in the second chamber 13 of the handle 10 but the turning piece 42 is left out of the second chamber 13. The rod 432 of the elastic driving device 43 is against the driven portion 33 of the pawl 30 and the elastic position device 14 is against the back side of the body 41 of the switch device 40. User can turn the turning piece 42 to drive the switch device turning between a first position (as shown in FIG. 4) and a second position (as shown in FIG. 5).

No matter whether the switch device 40 is turned to the first position and the second position, the distance between the proximal end 431 of the shoulder portion 43 and the pawl 30 are smaller than the distance between distal end 432 of the shoulder portion 43 and the pawl 30.

A cover 16 covers the opening ends of the receive hole 11 and the first chamber 12. The cover 16 has an opening 161 for the end of the driving member 20 passing through. A C-ring 17 is mounted in the second lock slot 23 on the driving member 20 to be against the topside of the cover 17. Thus, all elements of the ratchet wrench of the present invention are assembled.

Please refer to FIG. 4 again, user turn the turning piece 42 of the switch device 40 left to drive the body 41 switching to the first position, the driving device 44 at the front side of the body 41 will push the pawl 30 to switch to the first position. At this time, the shoulder portion 43 at left side of the body 41 will be against the left tail end of the pawl 30 and the rod 142 of the elastic position device 14 will be against the position portion 412 at right side as shown in FIG. 4. On the contrary, user turns the turning piece 42 of the switch device 40 right will drive the body 41 switching to the second position. The elastic driving device 43 will push the pawl 30 to switch to the second position and the rod 142 of the elastic position device 14 will be against the position portion 412 at left side. The shoulder portion 43 at right side of the body 41 will be against the right side of the pawl 30 as shown in FIG. 5.

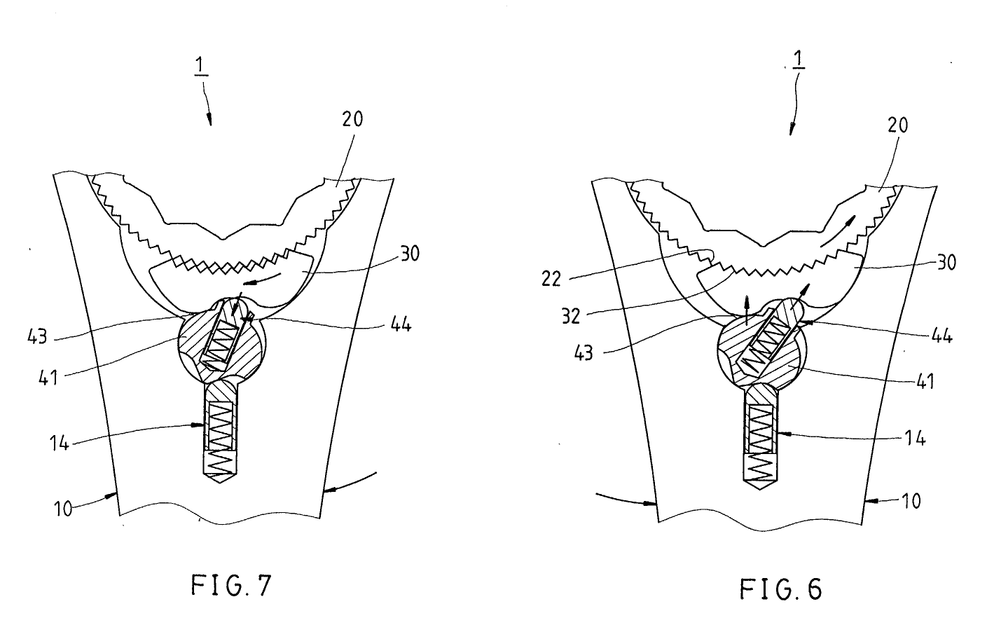

FIG. 6 shows the pawl 30 switched to the first position and user trying to turn the handle 10 counterclockwise to drive a bolt or a nut (not shown) to turn. The pawl 30 will be supported by the shoulder portion 43 of the switch device 40 to make the whole teeth of the teeth portion 32 of the pawl 30 meshing with the teeth portion 22 of the driving member 20. Thus, the ratchet wrench 1 of the present invention will have a superior power to drive the bolt (or the nut) to turn.

FIG. 7 shows the pawl 30 switched to the first position and user trying to turn the handle 10 clockwise. The pawl 30 will be driven to slide substantially along the arrow as shown in FIG. 7 to compress the elastic driving device 44 (the elastic position device 14 will be slightly compressed too). Thus, the pawl 30 can slide along the shoulder portion 43 and slightly depart from the driving member 20 to make the teeth portion 32 of the pawl 30 no longer meshing with the teeth portion 22 of the driving member 20. As a result, the handle 10 is turned reversibly but the driving member 20 but keeps the bolt still.

For the same principle, when the pawl 30 is switch to the second position, the relative actions will be as same as described above. So I will not describe again.

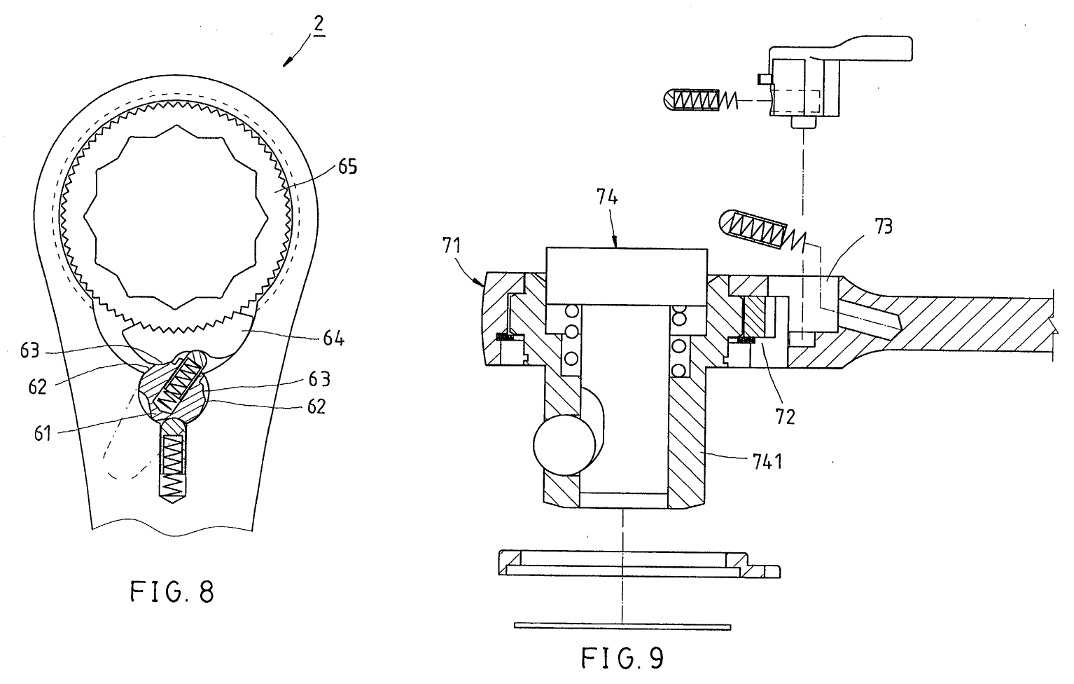

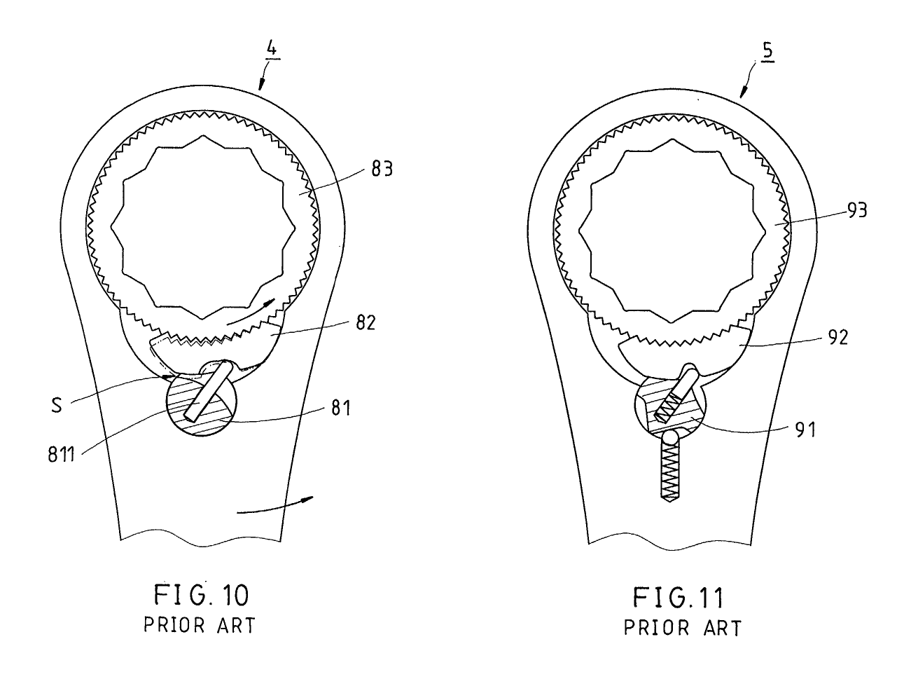

Please refer to FIG. 8, the second prefer embodiment of the present invention provides a ratchet wrench 2, which is similar to the first prefer embodiment, except that the shoulder portions 62 of the switch device 61 respectively disposes a recess face 63 thereon. The recess faces 63 on the shoulder portions 62 are the predetermined positions of the switch device 61 being against the pawl 64 when the switch device is turned to the first position and the second position. The recess faces 63 can make the switch device having a superior capacity to support the pawl 64 when driving the bolt to turn.

FIG. 9 shows a ratchet wrench 3 of the third prefer embodiment of the present invention, which is similar to the first prefer embodiment, except that the first chamber 72 and the second chamber 73 have openings respectively locating at the opposite sides of the head 71. The driving member 74 has a connect head 741 at a side thereof to detachably secure a socket (not shown) thereon.

What is claimed is:

1. A ratchet wrench, comprising:
a handle having a head at an end thereof; said head having a receive hole, a first chamber and a second chamber, wherein said first chamber communicating with said receive hole at a side thereof and communicating with said second chamber at the other side thereof;
a driving member received in said receive hole of said head for free rotating; said driving member having a teeth portion at out surface thereof;
a pawl having a teeth portion at a side thereof and a driven portion at the other side thereof; said pawl received in said first chamber of said head with said teeth portion thereof meshing with said teeth portion of said driving member; said pawl being driven to switch between a first position and a second position, and
a switch device having a body and a turning piece; said body of said switch device received in said second chamber of said head to be turned between a first position and a second position; said body disposing an elastic driving device thereon to be against said driven portion of said pawl, whereby turning said switch device to the first position will drive said pawl to switch to the first position and turning said switch device to the second position will drive said pawl to switch to the second position;
wherein said body of said switch device having two shoulder portions at two sides of said elastic driving device respectively; each shoulder portion having a proximal end, which is closing to said elastic driving device, and a distal end, which is far from said elastic driving device; said shoulder portion being a smooth face extending from said proximal end to said distal end; the distance between said proximal end and said pawl being smaller than the distance between said distal end and said pawl, whereby said shoulder portion being against said pawl when said switch device being turned to the first position and the other shoulder portion being against said pawl when said switch device being turned to the second position.

2. The ratchet wrench as defined in claim 1, wherein said receive hole of said head has a flange at an end thereof to be against a side of said teeth portion of said driving member and a lock slot disposed on the interior sidewall of said receive hole, a C-ring is mounted in said lock slot and is against the other side of said teeth portion of said driving member.

3. The ratchet wrench as defined in claim 1, wherein further comprises a cover secured on said head of said handle covering the opening ends of said receive hole and said first chamber.

4. The ratchet wrench as defined in claim 3, wherein said cover has an opening thereon for an end of said driving member passing through, said driving member has a lock slot at out surface to mount a C-ring therein for said C-ring being against said cover at exterior side thereof.

5. The ratchet wrench as defined in claim 1, wherein each shoulder portion of said switch device has a recess face thereon to touch said pawl.

6. The ratchet wrench as defined in claim 1, wherein said body of said switch device has two position portions thereon, said second chamber of said head has a recess at interior wall to dispose an elastic device therein, wherein said elastic position device has a spring and a rod for said rod will be against said position portion when said switch device is turned to the first position and said rod will be against the other position portion when said switch device is turned to the second position.

7. The ratchet wrench as defined in claim 1, wherein said body of said switch device disposes a recess thereon, said elastic driving device has a spring and a rod disposing in said recess.

8. The ratchet wrench as defined in claim 1, wherein driving member has a polygonal hole.

9. The ratchet wrench as defined in claim 1, wherein driving member has a connect head for connecting a socket thereon.
